(19) United States
(12) Patent Application Publication
(10) Pub. No.: US 2002/0175115 A1
(43) Pub. Date: Nov. 28, 2002

(54) Self-draining filtering system

(75) Inventor: Lloyd E. Weaver, Harpswell, ME (US)

Correspondence Address: Bourque & Associates, P.A., 835 Hanover Street, Suite 301, Manchester, NH, 03104, US

(73) Assignee: SeptiTech Inc.

(21) Appl. No.: 10/095,294

(22) Filed: Mar. 11, 2002

Related U.S. Application Data
(60) Provisional application No. 60/275,018, filed on Mar. 13, 2001.

(51) Int. Cl. C02F 1/00

(52) U.S. Cl. 210/153

(57) ABSTRACT

A filtering apparatus for filtering sand, other debris, and pollutants from rainwater does not utilize electricity or complex valves. The apparatus includes a tank, preferably concrete, having at least one inlet, an overflow outlet, and a filter proximate the tank outlet. The overflow outlet in one embodiment comprises an overflow weir having at least one side and an open top. A screen is attached to the top of the overflow weir and/or the tank outlet, and is preferably made from stainless steel or plastic. The screen is preferably sized to filter sand. In use, rainwater enters the tank, debris settles, and water exits the outlet and the filter. When a large amount of fluid enters and fills the tank, the fluid level reaches the overflow. At this point, any excess rainwater that cannot exit through the screen will flow over and into the overflow opening and exit the tank outlet.

### CROSS-REFERENCE TO RELATED APPLICATIONS

This application is related to and claims the benefit of Provisional U.S. Patent Application No. 60/275,018 entitled Surging Sand Trap With Self-Draining Method, filed on Mar. 13, 2001 by the Assignee of the present invention, and incorporated herein by reference.

### TECHNICAL FIELD

The present invention relates to systems for filtering materials from fluids and more particularly, relates to a system for trapping sand, other debris, and pollutants from liquids that is particularly useful for drainage areas on roads and parking lots during rainstorms.

### BACKGROUND INFORMATION

Various methods are used to trap sand or debris and pollutants from roadway water discharge. Some are flooded-open and closed tanks, and maintained full of water. These tanks require that the water be pumped out prior to emptying the tank of the entrapped debris. The resulting water usually becomes highly concentrated with pollutants and is difficult and time consuming to pump, and expensive to treat.

Other known methods include the use of canisters and various filters and valves. Many of these systems are complicated and require electrical energy to operate or rely upon a complex series of valves. These systems are expensive to operate and require a lot of maintenance. Furthermore, the use of filters requires sanitation workers to climb into the tanks to replace the filters. This is time consuming, dangerous, and expensive since it requires the sanitation workers to enter confined, polluted areas.

For the above reasons, it would be desirable to provide a filtration apparatus that is easy and inexpensive to operate. It should not require the use of electricity or involve complex valves.

### SUMMARY

According to one embodiment, the present invention is an apparatus for filtering material entrapped in a fluid. The apparatus includes a tank, at least one overflow weir, and at least one filter. The tank has a top and a bottom, at least one inlet and at least one outlet. The overflow weir has a height and an open top.

In one embodiment, the tank includes at least one opening. In a further embodiment, the opening includes a grate. The tank and overflow weir may be made of concrete, stainless steel, or plastic. The filter may be made of stainless steel or plastic.

### BRIEF DESCRIPTION OF THE DRAWINGS

These and other features and advantages of the present invention will be better understood by reading the following detailed description, taken together with the drawings wherein:

FIG. 1 is a side plan view of one embodiment of the present invention;

FIG. 2 is a top plan view of one embodiment of the present invention;

FIGS. 3A-3C are front, end and top views respectively of another embodiment of the present invention; and

FIGS. 4A-4C are front, end and top views respectively of yet another embodiment of the present invention.

### DETAILED DESCRIPTION OF THE PREFERRED EMBODIMENTS

The filtering apparatus 10, FIG. 1, according to the present invention includes a tank 12 having at least one inlet 14 and at least one outlet 16. The tank 12 may be made out of plastic, or metal, but is preferably concrete. The inlet 14 and outlet 16 can be positioned anywhere, but a preferably at opposite ends of the tank 12. Having the inlet 14 and outlet 16 at opposite ends of the tank 12 allows for maximum settlement or dwell time. Also, the inlet 14 is preferably placed near the top of the tank 12 and the outlet 16 is place near the bottom of the tank 12. Placing the outlet near the bottom allows the tank 12 to drain completely. If residual water is desired, the outlet may simply be raised off the bottom of the tank 12.

The filtering apparatus 10 also includes an overflow weir 18 having at least one side 20 and an open top 22. The overflow weir 18 is preferably attached to at least one side or end of the tank 12. The exact dimensions and size of the overflow weir 18 will be dictated by the specific application and dimensions of the filtering apparatus 10 and is within the skill of one of ordinary skill in the art. As shown in the drawing, the preferred embodiment of the overflow weir is a three-sided weir with an open top area. The overflow weir 18 is preferably made out of metal, plastic, or concrete.

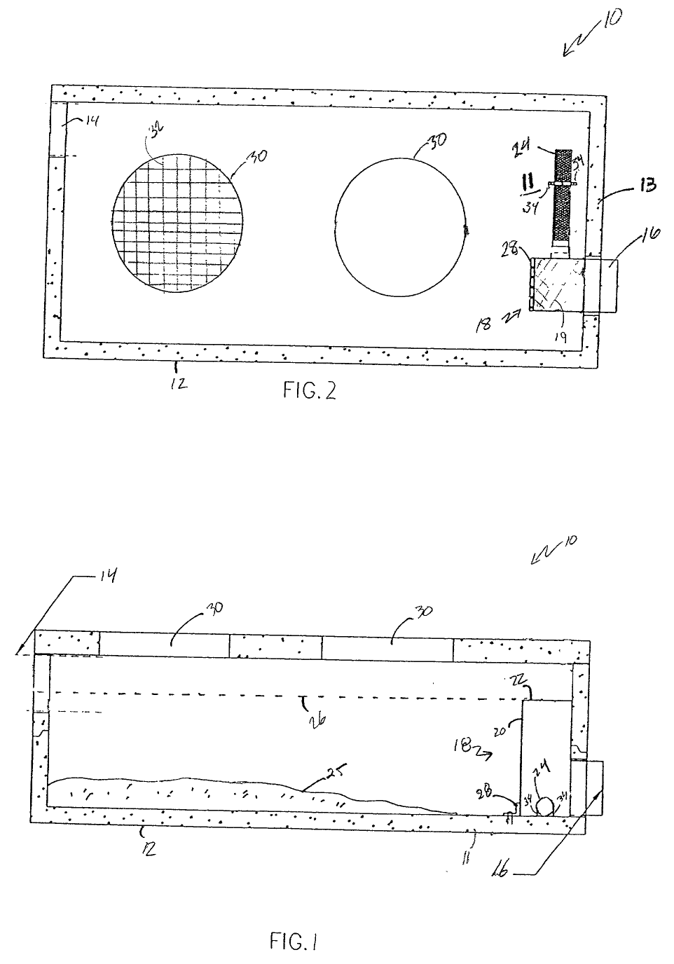

In another embodiment, the overflow weir 18 may include an overflow weir screen 19, FIG. 2, placed on the top 22 of the overflow weir 18. The overflow weir screen 19 prevents any solids 25 that do not settle (e.g. floating debris) from plugging the outlet 16 of the apparatus 10. In a further embodiment, the top 22 of the overflow weir 18 may be angled (not shown) so that any solids 25 trapped on the overflow weir screen 19 roll off onto the bottom 11 of the tank 10 to prevent the overflow weir screen 19 from becoming blocked.

A filter 24 is attached to a least one side of the overflow weir 18. The exact position of the filter 24 will depend upon the specific application and dimensions of the of the filtering apparatus 10 and is within the skill of one of ordinary skill in the art.

In a preferred embodiment, the filter 24 is attached to the bottom 11 of tank 12 via bolts 34, and is positioned parallel to the outlet wall 13 of the tank 10. Other filter attachment means such as, but not limited to, hangers and the like, and other filter positions, such as a vertical placement, are also envisioned. The filter is made of plastic or metal. The size of the voids within the filter 24 depend upon the circumstances of its intended use, but generally are small enough to stop sand yet large enough to allow water to easily flow through without becoming clogged. A 40 mesh stainless screen is considered to be generally acceptable.

In practice, fluid, generally rainwater from a road or parking lot, containing a solid 25, generally sand, leaves, and pollutants, enters the tank 12 through inlet 14. The fluid fills the tank 12 and most of the solid material 25 settles to the bottom of the tank 12. The fluid flows through the filter 24 and into the overflow weir 18 where it exits the tank 12 through outlet 16.

When a surge of water enters the tank 12 at a rate greater than can exit through filter 24 or if filter 24 becomes essentially blocked, the fluid level 26 begins to rise up against side 20 of the weir until the fluid level 26 reaches the top 22 of the overflow weir 18. At this point, at least a portion of the fluid begins to flow over the side/top 22 of the weir 18 and exits the tank 12 through the outlet 16. The tank 12 is preferably sized to allow sufficient dwell/settling time to allow the solids 25 to settle to the bottom of the tank 12. The solids 25 entrapped within the filtering apparatus 10 aid in filtration.

During periods of low to moderate fluid flow, the fluid must flow through the remaining solids 25. The remaining solids 25 act as a “filter” by entrapping many of the solids in the fluid before the reach the fluid reaches the filter 24. In this way, the tank 12 will not back-up.

In one embodiment, the overflow weir 18 is plastic and contains a bracket 28 to secure it to the tank 12. When using concrete overflow weirs, it is preferably to use a layer of sealant (not shown), preferably asphalt, to prevent leaking. In another embodiment, the tank 12 includes at least one opening 30 in the top of the tank, thereby allowing access to the tank 12. In a further embodiment, at least one opening 30 includes a removable grate 32, FIG. 2.

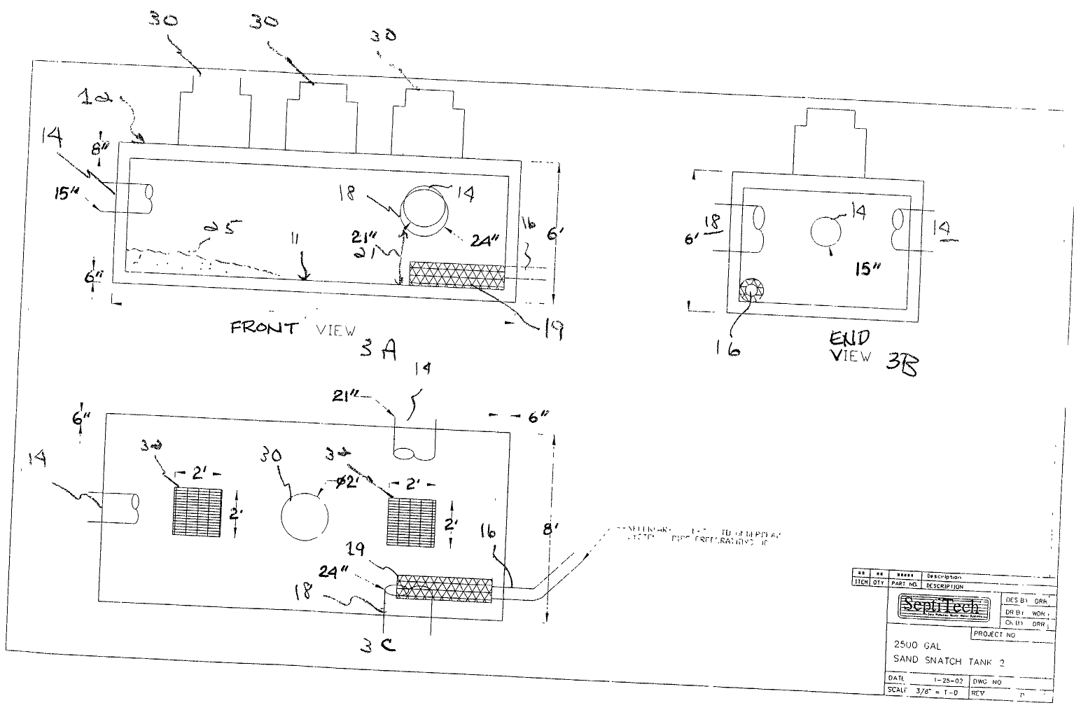

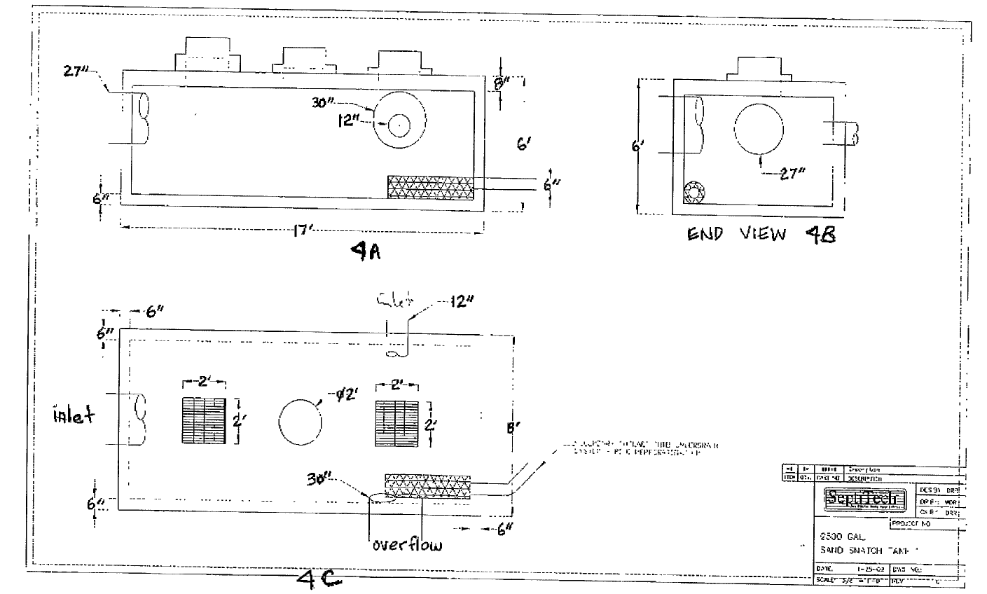

In another embodiment shown generally in FIGS. 3A-3C and 4A-4C, the tank 12 includes at least one separate overflow outlet 18 located a predetermined height 21 from the bottom 11 of the tank 12. The diameter and height 21 of the overflow opening 18 is determined to match the expected heaviest storm rate expected to be encountered. Outlet pipe 16 surrounded by mesh 19 is located approximately 3″ off the bottom 11 of the tank 12. One of more outlets 16 may be provided. In addition, one or more inlets 14 may also be provided based on the inlet flow rate expected and the desired retention and decanting rate within the tank 12.

Modifications and substitutions by one of ordinary skill in the art are considered to be within the scope of the present invention, which is not to be limited except by the following claims.

The invention claimed is:

1. An apparatus for filtering material entrapped in a fluid comprising:
a tank having a top and a bottom and at least one inlet and at least one outlet;
at least one overflow outlet having a height and an open region;
at least one filter attached to said at least one outlet; and
wherein said overflow outlet is fluidly coupled to said at least one outlet, wherein in a first mode of use, said fluid flows into said tank and through said at least one outlet through said at least one filter attached to said at least one outlet, and wherein in a second mode of use, at least a portion of said fluid flows into said overflow outlet to said at least one outlet.

2. The apparatus as claimed in claim 1 wherein said tank further includes at least one opening, said opening being sized to allow easy access to said tank.

3. The apparatus as claimed in claim 2 wherein said opening includes a grate.

4. The apparatus as claimed in claim 1 wherein said inlet is positioned near said top of said tank.

5. The apparatus as claimed in claim 1 wherein said outlet is positioned near said bottom of said tank.

6. The apparatus as claimed in claim 1 wherein said tank is constructed generally of a material selected from the group consisting of concrete, synthetic material, and metal.

7. The apparatus as claimed in claim 1 wherein said overflow outlet includes an overflow weir constructed generally of a material selected from the group consisting of concrete, synthetic material, and metal.

8. The apparatus as claimed in claim 1 wherein said filter coupled to said outlet is positioned near said bottom of said tank.

9. The apparatus as claimed in claim 7 wherein said overflow weir further includes a screen attached to said top of said overflow weir which generally prevents said material entrapped in said fluid from plugging said outlet of said tank.

10. The apparatus as claimed in claim 9 wherein said overflow weir screen comprises a self-cleaning overflow weir screen.

11. The apparatus as claimed in claim 10 wherein said top of said overflow weir and said overflow weir screen are sloped allowing said filtered material to roll off said overflow weir screen onto said bottom of said tank.

12. The apparatus of claim 1 wherein said weir includes three sides.
